(19) United States
(12) Patent Application Publication
(10) Pub. No.: US 2008/0140626 A1
(43) Pub. Date: Jun. 12, 2008

(54) METHOD FOR ENABLING DYNAMIC WEBSITES TO BE INDEXED WITHIN SEARCH ENGINES

(76) Inventor: Jeffery Wilson, Goleta, CA (US)

Correspondence Address: K.P. CORRELL AND ASSOCIATES, L.L.P., 270 BELLEVUE AVE., #326, NEWPORT, RI, 02840, US

(21) Appl. No.: 11/835,342

(22) Filed: Aug. 7, 2007

Related U.S. Application Data
(62) Division of application No. 10/824,714, filed on Apr. 15, 2004, now abandoned.

(51) Int. Cl. G06F 17/30

(52) U.S. Cl. 707/3; 707/E17.108

(57) ABSTRACT

A method for improving a search engine index of a web page hosted on a web server by determining a search engine index constraint in the initial web page, then creating a second web page based upon the search engine index constraint determined on the initial web page. The second web page is created by removing the search engine index constraint in the first web page, linking the first web page to the second web page, and hosting the second web page on a web accessible media. Additionally this invention allows search engine users to access the web site pages after performing a search at a search engine.

### CROSS REFERENCE TO RELATED APPLICATIONS

This application claims the benefit of U.S. Provisional Application No. 60/464,077, filed Apr. 18, 2003. The disclosure of this provisional Patent Application is incorporated by reference herein in its entirety. This is a division of co-pending application Ser. No. 10/824,714, filed Apr. 15 , 2004.

### BACKGROUND OF THE INVENTION

1. Field of the Invention

The present invention relates to indexing dynamic websites within search engines, and, more particularly, to indexing dynamic websites within search engines so that they achieve high rankings within the search engines.

2. Description of Related Art

The following prior art is known to Applicants: U.S. Pat. Application No. 20030110158 to Seals discloses a system and method for making dynamic content visible to search engine indexing functions, by creating static product related web pages from database contents, but does not address recursively performing these functions on the navigation of those dynamic web pages, as they relate to the other web pages within the web site, or to other web sites, nor does it teach creating the links on static pages such that they link back to dynamically generated pages.

### BRIEF SUMMARY

As will be described below, important aspects of the invention reside in the converting of dynamic web pages to static web pages, and modifying aspects of both dynamic and static web pages such that they rank higher within the search engines.

This is achieved by recursively creating static content out of dynamic pages, and linking those static pages to both static and dynamically created web pages, in order to mimic the original navigation of the web site to both search engine crawlers, and web site visitors. This invention relates to helping dynamic web sites become better represented in important search engines like Google and MSN.

This invention is designed to allow search engine crawlers to access information on web pages within web sites that the search engine crawlers would not otherwise be able to access because the page URLs are not compatible with the search engine crawler, or because visitors must log into the site before being granted access to certain pages, or because there are no link path to these pages from the web site home page. Additionally this invention allows search engine users to access the web site pages after performing a search at a search engine.

In accordance with one embodiment of the present invention a method is disclosed for a for improving a search engine index of a web page hosted on a web server by determining a search engine index constraint in the initial web page, then creating a second web page based upon the search engine index constraint determined on the initial web page. The second web page is created by removing the search engine index constraint in the first web page, linking the first web page to the second web page, and hosting the second web page on a web accessible media.

In accordance with another embodiment of the present invention a web server, comprised of a first web page, is optimized for search engine compatibility. The first web page is comprised of search engine constraints, and at least one second web page linked to the first web page. The second web page is comprised of the first web page optimized for search engine indexing.

In accordance with yet another embodiment of the present invention a program storage device, readable by a machine, tangibly embodying a program of instructions executable by the machine to perform method steps for improving a search engine index of a first web page, is hosted on a first web server. The method steps are comprised of determining at a first web page search engine index constraint in the first web page, and creating a second web page based upon the search engine index constraint. The second web page is created by removing the search engine index constraint in the first web page, linking the first web page to the second web page, and hosting the second web page on one web accessible server,

### BRIEF DESCRIPTION OF THE DRAWINGS

The foregoing aspects and other features of the present invention are explained in the following description, taken in connection with the accompanying drawings, wherein:

FIG. 1 is a pictorial diagram of a web server system.

FIG. 2 is a method flow chart showing steps for one method of implementing the present invention.

FIG. 3 is a block diagram implementing one embodiment of the present invention.

### DETAILED DESCRIPTION

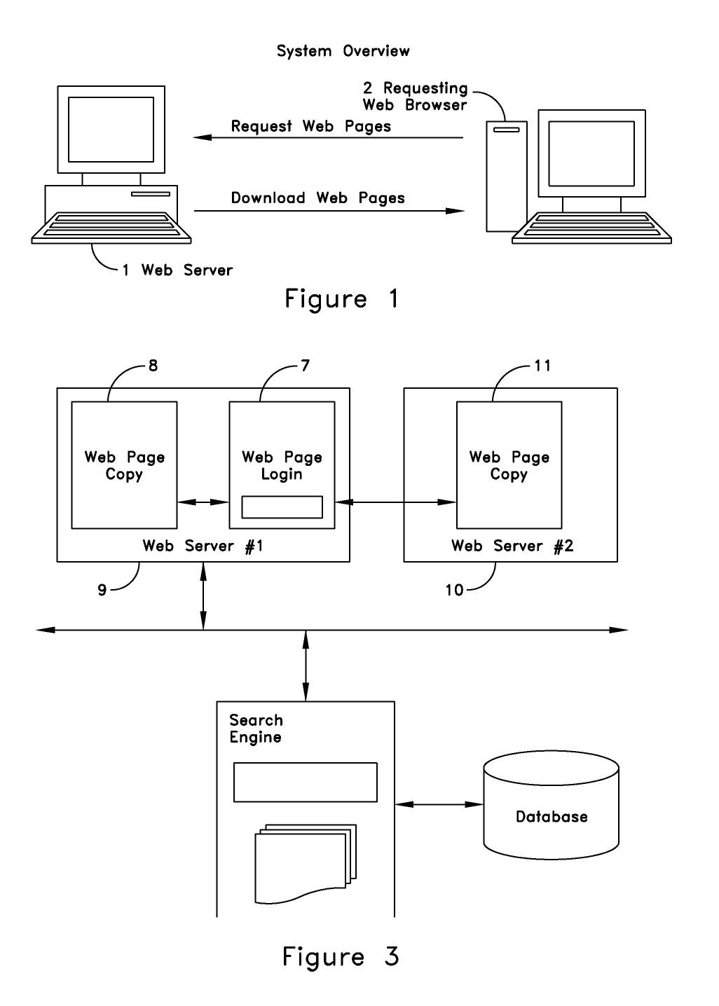

Referring to FIG. 1, there is shown a pictorial diagram of a web server system incorporating features of the present invention. Although the present invention will be described with reference to the embodiment shown in the drawings, it should be understood that the present invention might be embodied in many alternate forms of embodiments, e.g., automated computer programs requesting pages from web servers. In addition, it should be understood that the teachings herein may apply to any group of web sites or web servers; as illustrated in FIG. 1.

Referring again to FIG. 1, the world wide web on the Internet is a network of web servers 1. World wide web users, including people using web browsers 2, and also including automated computer programs, request web pages from these web servers 1. The requests are made in accordance with the Hyper Text Transport Protocol (HTTP), and include a Universal Resource Locator (URL) to identify the requested page. (More than one URL may identify the same web page, as described below.) Referring again to FIG. 1, the web server 1 then delivers the web page back to the requesting web browser 2 or computer program. The request and subsequent delivery of a web page is referred to as “downloading” a web page. The web page may be a Hyper Text Markup Language (HTML) document, or other type of document or image. The web page may be copied from a static file on the web server (static delivery), or be constructed by the web server on the fly each time the web page is requested (dynamic delivery).

Referring to FIG. 3, Search engines 3 are designed to help world wide web users find useful web pages among the billions of web pages on the world wide web. Search engines 3 do this by downloading as marry web pages as possible, and then recording information about these pages into their databases 4; a process referred to as indexing web pages. The search engines provide a user interface whereby users can enter keyword query expressions. The search engines then find the most relevant web pages from their database, and deliver a list of them back to the search engine user. Typically the search engine user interface is a web page with an input box 5, where the user enters the keyword query expression, and the results 6 are delivered back to the user on a search engine results page that includes a summary, and a link to relevant web pages found.

One way that search engines find pages on the world wide web to index is by the crawling process. Crawling (by search engine crawlers or by other computer programs) involves downloading the source code of web pages, examining the source code to find links or references to other web pages, downloading these web pages, etc.

The source code of the web page is the data downloaded when the URL is requested. The source code may be different each time it is downloaded because; a) the page may have been updated between downloads, b) the page may have some time dependant features in it—for example the time of day may be displayed, or c) some details of the source code may depend on details of the URL used to access it.

Search engines on the Internet (Google, Yahoo, etc.) have difficulties indexing dynamic websites. This invention provides a means to help them to index dynamic websites better.

Search engines have difficulties indexing dynamic websites because their web page URLs are typically not unique for each page. The URL of a particular web page, (say a particular product description page), may be different for each visitor to the site, and/or may be different depending on what pages the visitor had viewed previously. This makes it difficult for search engines to know if any particular URL is a new page, or one that is already in their index.

The URL for a typical dynamic page includes one or more “parameter=value” pairs, separated by ampersands, like this: (the three parameter=value pairs are underlined)
http://www.domain.com/page.asp?sessionID=2345&productID=1234&previouspage=home

In this case it is only the file name (page.asp) and the productID that are needed to identify the web page, however the search engine has no way of knowing this. The search engine must use the entire URL to identify the page, or guess which parameters are session/tracking parameters and which parameters are content parameters.

Currently search engines deal with this problem by creating and following heuristic rules that determine whether or not any particular parameter is a session or tracking parameter, whether to ignore these URLs completely, whether to ignore any particular parameter=value pairs, or whether to treat a particular URL as a unique identifier of a unique web page. The search engines follow these rules to decide whether to download any particular URL.

Once a search engine has downloaded a URL, they also have the option of comparing the downloaded content to other content they have downloaded, and then making further conclusions regarding whether this page is a new page. However it is much, better if the search engine can make these determinations before downloading a URL—because downloading web pages only to determine that they are duplicates of web pages that they already have is expensive.

In an alternate embodiment a search engine may download a particular web page of a website in order to learn about the URL parameters used within, the website, and thereby is better able to index the website. For example, URL parameter information, could be included in the robot.txt file in the root folder of a website. Most search engines download this file already to learn which web pages to include, and which pages to exclude from their index. Currently the published specification for the robot.txt file does not include means of describing the function of any particular URL parameters.

For example, one method for adding URL parameter information to the robot.txt file is as follows:
One or more string matching patterns are defined on the file. These patterns are intended to identify the static portion of certain URLs found on the website—that is the part of the URL before the question mark, for example “/cgi/productDetail.asp”. (The standard wildcard character would be recognized.)
For each pattern defined above, one or more lists of URL parameters may be defined. For example these lists of parameters may be defined:
non-content-parameters=sessionID, previouspage (The search engines would use these when downloading but not for identification, or when sending search engine users to the website.)
skip-if-present-parameters=memberID
ignore-other-parameters-if-these-present=sku

In general a web page downloaded at the same time from different web browsers will look similar if not exactly the same.

In some cases there may be a one to one relationship between web pages and the URL's used to access them. For example “http://www.companyA.com/article17.html” may be the one and only URL used to access a particular web page. These sites are the easiest to crawl.

In other cases many URL's may access the same web page. For example “http://www.companyB.com/showArticle.asp?articleID=17&sessionID=1234&fromPage=home” would access the current web page showing article number 17. If the “sessionID” above were changed to “sessionID=5678” then the resulting URL would still access the same web page. This site would be more difficult to crawl because the crawling program may not know that both URL's lead to the same web page.

In other cases the relationship between web pages and the URLs used to access them may be non-deterministic. For example the URL “http://www.companyB.com/NextPage.asp” may be used over and over again to access completely different web pages. This site would not be successfully crawled by most crawlers because they would only download this URL once during a particular crawl.

In other cases the relationship between web pages and the URLs used to access them may be vague. For example, if the only difference in the source code downloaded from two different URLs is a minor feature on the page such as the “bread-crumb” navigation line (a form of navigation where the user is shown the path from the top level web site to the current page), then it would be a judgment call as to whether these are two distinct web pages, or the same web page.

Search engines have limited, resources, and must choose which pages to index.

Search engines often ignore URL's with many parameters after the question mark, in order to avoid indexing the same web page many times via different URL's. In general, search engine employees do not personally visit the web sites being indexed because there are far too many of them. The search engine must use pre-defined rules to decide which URLs to index and which to ignore.

User logins 7 often stop search engines from indexing web pages, Web site owners sometime want to collect personal information from the web site visitors in order to qualify them as potential customers. These web site visitors may be required to provide contact information as they sign up for a web site user name and password. The user must use this username and password to login before accessing content on the web site. Search engine crawlers cannot sign up for a username and password, and therefore, cannot index these pages.

There may not be a link path from the home page to all the pages in the web site. Instead the web site may depend on navigation based on JavaScript written links or form submission—both invisible to search engine crawlers.

It is therefore an object of the present invention to provide a method and system to help search engines index information on web pages that they otherwise would not be able to index because the URLs are too complicated, or because the search engines crawlers are blocked by a login requirement, or because link paths are not available to all pages of a site.

It is a further object of the present invention to provide a method and system to help search engines index information on web pages without “spamming” (violating the search engine's guidelines) the search engines, that is, without creating “hidden content,” without “deceptively redirecting” visitors to different pages than the ones indexed by the search engines, and without “cloaking.”

“Hidden content” is text on web pages that is visible to search engine crawlers, but invisible to human web site visitors. Often, this is accomplished by adding text on a web page, using the same font color as the background of the web page, so that the text appears invisible on the web page. Search engines forbid this tactic because it can be used to fool search engine into ranking a particular page higher than they would otherwise.

“Deceptive redirecting” is another form of “hidden content” where web pages are created for search engine crawlers, but when human visitors visit the pages, the human visitors are redirected to a different page with different content.

“Cloaking” is a practice where search engine crawlers are given one version of a web page, and human visitors are given a different version.

It is still a further object of the present invention to provide a method and system to help search engines index information on web pages which use frames. Care must be taken so that when a search engine user executes a search at a search engine, and clicks on a link to a “frame source page,” that the page will come up loaded correctly within its frameset. Without care, the page will come up by itself, without the surrounding frames.

This system is designed to allow search engine crawlers to access information on web pages within web sites that the search engine crawlers would not otherwise be able to access, either because the page URLs are not compatible with the search engine crawler, or because visitors must log into the site before being granted access to certain pages, or because there are no link paths to these pages from the web site home page. Additionally, this system allows search engine users to access the web site pages after following a link from a search results page.

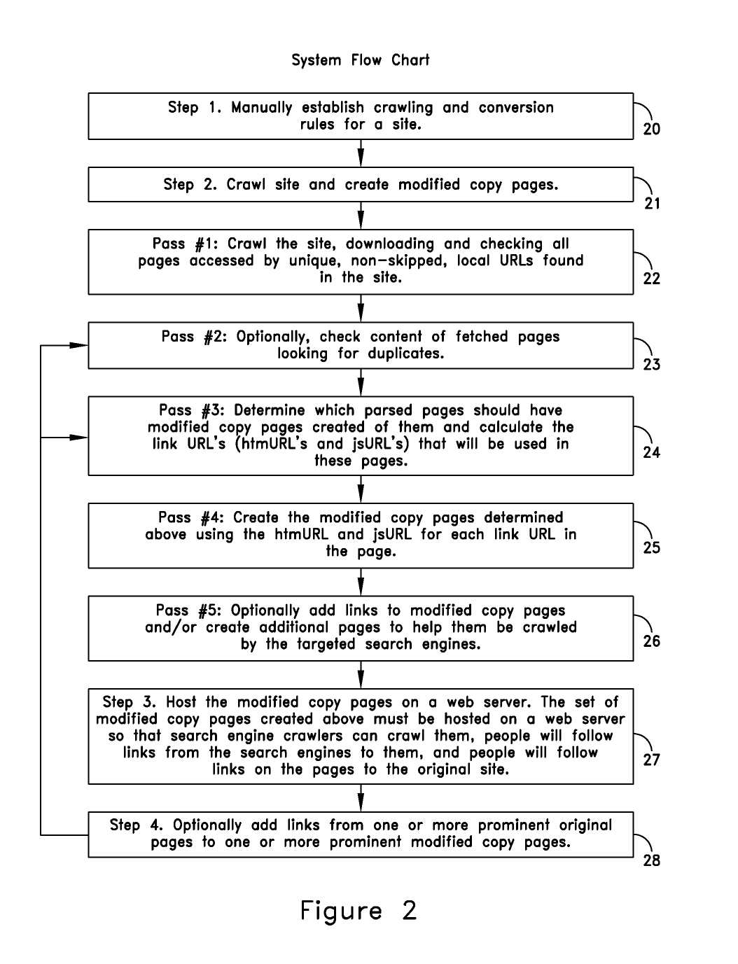

Referring to FIG. 2, there is shown a flow chart for the present invention. Step 1 (20) provides for manually establishing crawling and conversion rules for a site. Rules are set up for a site manually by adjusting program settings and/or by writing custom code—this information being stored and accessed for each site operated on. The process of setting up these rules will typically involve setting some rules, partially crawling the site, checking the results, adjusting the rules, re-crawling the site, etc.

Referring again to FIG. 2, Step 2 (21) provides a method of crawling the site, and creating modified copy pages. This method is divided into five sections, identified as Pass # 1 through Pass #5.

During Pass #1, (22) and Pass #2, (23) the system crawls the web site, identifying pages to create modified copies of, and if necessary, accounting for multiple URLs leading to the same page. (Web pages identified to create modified copies of are referred to as “original pages,” and the new pages created are referred to as “modified copy pages”).

This process involves starting at one or more predefined web pages, and downloading their source code. This source code is examined to find links to other web pages. (Each of these links includes the URL to be used to access the destination web page or document. Multiple URLs may lead to the same web page or document.)

Accessing the starting web pages may include posting data to the web server, particularly in order to expose pages with no link path from the home page.

For each link found, a determination is made (and acted upon) whether or not to download, and examine the destination web page to find more links. This determination may be made in a number of ways not limited to:
a) Comparing link URL to some predefined criteria.
b) Comparing feature of the link, or the page on which the link is found, to some predefined criteria.
c) Comparing feature of the destination page to some predefined criteria, this method requiring that the HTTP header, and/or the destination page itself be downloaded.

Referring to the Table 2, The Crawl List, Pass #1 Algorithm and Functions, and again to FIG. 2, Pass #1 (22), initially, the Crawl List will be empty or will contain old “Copied” records from previous crawls with their state set to “Old” and only these fields set: rowID, idURL, fURL/fPost (for manual reference only), hide-true, and sFile. sFile is the important one, which is used if this record becomes a copied page record. These fields are blank: lnkText, lnkFrm, redirectTo, redirectType, fOrder, htmURL, jsURL, fetchID, mTTL, mDSC, and mKW.

Referring to FIG. 3, and Table 2 The Crawl List, at the end of pass #1 (22), the Crawl List will contain a record for every unique URL found on non-Skipped pages in the site (the site is defined by the IsLocal test in the CheckOrgURL function).

Unique URLs are calculated from original URLs found in the starting list, in links, in redirects, and in location headers. The calculation is performed in the CheckOrgURL function as follows: orgURL=>fURL=>IsLocal test=>idURL.

Non-skipped pages are defined by the SkipByURL, SkipByContent, SkipByLink and SkipErrorPage functions.

These unique URL records will have their state field set to “Redirect”, “Outbound”, “Skipped by Link”, “Skipped by URL”, “Skipped by Type”, “Skipped by Content”, “Error Page”, “Failed”, or “Parsed”. All “parsed” URLs will have an associated fetch ID and cashed source code file. Some parsed pages may have their sFile and lnkText fields set due to their definition in the starting URL list. (Any un-used “Old” records from previous crawls will remain.)

The redirectTo field of Redirect records point to the redirected-to or location specified records. The redirectType field stores the type of the redirect. (Otherwise the RedirectTo field is zero or Null.)

Referring again to FIG. 2, Pass #2 (23), some pages may meet these tests, but are not downloaded and examined, because it is determined that they have already been downloaded and examined during the current crawl. This determination may be accomplished in a number of ways not limited to:
a) The preferred method is to calculate a “page identifying value” from the URL used to access the page. This page identifying value is then compared to a “crawl progress data store” to determine whether or not the page has already been downloaded and examined.
b) An alternative method is to download each unique URL discovered (or a programmatically modified version of each URL discovered) which meets some predefined criteria. A page identifying value is then calculated from the web page or document downloaded. The URLs and page identifying values are stored in a crawl progress data store, along with whether or not the page has been examined. This method may not be ideal because there may be a high number of URLs used to access the same page, and/or there may be some time dependant feature on the page/document that makes it difficult to calculate the same page identifying value from the source code of the same page/document downloaded at different times.

Note that the goal of a) and b) is to reduce the number of pages that are downloaded, examined, and potentially copied, more than one time during each crawl.

Referring to Pass #2 Algorithm and Functions, and again to FIG. 2, Pass #2 (23), the calculation of idURL, in accordance with site-specific settings, goes a long way towards identifying unique pages in the site. Optionally, the content on the pages may be considered—the simplest way being to calculate a hash based on the source code. More elaborate methods are possible in which pages not exactly equal, may still be considered duplicates.

Referring again to FIG. 2, Pass #3 (24), for each page downloaded and examined, a determination is made whether or not to create a modified copy of the page. This determination may be based on a web page containing a link to the page, or be based on the URL of said link, or be based on the page itself, or some other criteria.

Referring to Pass #3 Algorithm and Functions, and again to FIG. 2, Pass #3 (24), a determination is made as to which parsed pages should have modified copy pages created of them and assign a sFile value to them and set their state to “Copy”. Calculate htmURL and jsURL for all non-“Old” and non-“Redirect” records. Follow each “Redirect” record to its final destination record and copy the state, hide, htmURL, and jsURL fields back to the redirect record.

Note that the htmURL and jsURL are used in modified copy pages. The link URL in the source code that originally pointed to a certain page represented in Table 2, The Crawl List, is changed to the htmURL for that record. If a jsURL is set for that record then JavaScript is added to the page to change the link to the jsURL. In this way search engine crawlers follow the links to the htmURL and human visitors follow the links to the jsURL.)

After this pass, all the records that should have modified copy pages made have their state set to “Copy”. All non-“Old” pages have their htmURL and jsURL fields set.

Optionally, during the crawling process, HTTP headers may be provided which simulate those provided by web browsers such as Microsoft Internet Explorer, or Netscape Navigator. These may include the acceptance and returning of cookies, the supplying of a referring page header based on the URL of the page linking to the requested page, and others.

Optionally, at some point during the crawling process, HTTP requests may be performed in order to log into the web site and be granted access to certain pages. These HTTP requests may include the posting of data and the acceptance and returning of HTTP cookies.

Referring to Pass #4 Algorithm, and again to FIG. 1 and FIG. 2, Pass #4 (25), the modified copy pages are assigned URLs, and constructed so they are linked to each other, the links being crawl-able by the targeted search engine crawlers. One method of linking the web pages together is to simply add links leading to other modified copy pages, these links being optionally hidden from users viewing the page with a web browser.

The preferred method is to construct the page so that links, which in the original page 7 led to other pages to be copied, instead lead to the corresponding modified copy page 8. Means is provided so that users are either automatically shown an original page 7 after requesting a modified copy page 8, or they are directed to an original page 7 after following a link (or submitting a form) on a modified copy page 8. The preferred method is as follows:

Assign a URL that will be used to access the modified copy page 8. The URL should be crawl-able by the targeted search engines. This URL may be the next in a sequence like p1.htm, p2.htm, etc, or may be calculated from the original URL.

The modified copy page 8 is constructed such that each link in it, which in the original page 7 led to another page to be copied, leads instead to the corresponding modified copy page 8. Thus the collection of modified copy pages are linked to each other in the same way as the original pages are linked to each other.

One or more client side scripts (run by web browsers but not by targeted search engine crawlers) are included in the modified copy page, or otherwise provided, that convert each link in the page leading to another modified copy page 8 to lead instead to the corresponding original page 7. (This would include one or more scripts that modify the link URL only when the link is followed using the links onClick event.) The URLs used to access these corresponding original pages may be the URLs found in the links on the original page 7 of this modified copy page 8, or may be programmatically created URLs that also lead to the corresponding original pages 7. (For example the session parameters may be removed so a new user session will be started when a user clicks on the link.) The result is that a user clicking on any of these links will consequently download an original page 7.

Optionally, the modified copy page 8 is constructed such that the URL of certain links to other pages that are NOT copied, is a programmatically created URL leading to the same page. (For example the session parameters may be removed so a new user session will be started when a user clicks on the link.)

The modified copy page 8 is constructed, or other means are provided, so that relative URL references from its original page, which have not been otherwise modified as described above, will continue to work. (This may mean, among other possibilities, adding a <base href> tag near the top of the HTML, or may mean modifying all these relative URL references, or may mean creating copies of the referred to resources and pointing these URLs to the copies.)

Optionally, the modified copy page 8 is constructed with a hit counter script or other means is provided to record the page usage.

Optionally, the modified copy page 8 is constructed to emphasize desired keywords better than the original page does. This may include adjusting the title or meta tags from the original page. It may include rearranging the internal structure from the original page in order to move the unique content higher up in the source code. In certain cases, it may mean including text in the modified copy page 8 that is not present in the original page 7.

Optionally, the modified copy page 8 may include links not present in the original page 7, these links being included, among other reasons, to emphasis keywords and/or help search engine crawlers find certain pages.

When viewed in a web browser the modified copy page 8 should look and act similar, if not exactly the same as the original page 7.

A non-preferred alternative is to hide the modified copy page 8 from being displayed in web browsers, and instead display the original page 7 in web browsers. This can be accomplished in number of ways not limited to:

i. including a client-side redirect in the modified copy page 8 that the web browser (but not targeted search engine crawlers) follows to the original page 7.

ii. delivering the modified copy page 8 OR a redirect to the original page 7, depending on HTTP headers and/or the IP address (or other details) used to request the page.

iii. delivering the modified copy page 8 OR the original page 7 depending on HTTP headers and/or the IP address (or other details) used to request the page. (The source code of the original page 7 may be modified to load correctly.)

iv. including a JavaScript written frameset in the modified copy page 8 that displays the original page 7 in a full sized frame. (The source code of the original page 7 may be modified to load correctly or so that the base target of links is the “_top” frame.)

In the preferred implementation, the modified copy page 8 is saved to a computer readable media, the alternative being to create the modified copy page 8 dynamically each time it is requested.

Referring again to FIG. 2, Pass #5 (26), optionally add links onto modified copy pages and/or create additional pages to help them be crawled by the targeted search engines. Search engine crawlers following links from one modified copy page to the next should find many of the modified copy pages. However, all of them may not be found because link paths may not exist to all of them or because the search engine crawler may only follow the first 50 or so links on any particular page and ignore the rest. Referring to Pass #5 Algorithm, and again to FIG. 1 and FIG. 2, Pass #5 (26) this problem can be solved by creating a supplemental site map, and/or systematically adding links from each modified copy page to other modified copy pages, and/or inserting specific links on specific pages as defined by the setting for the site.

One or more “keyword pages” may be added to the group of modified copy pages, these pages being manually created to match the look and feel of the web site, and be considered highly relevant by the targeted search engines for the desired keywords.

Optionally, one or more “site map” pages may be added to the group of modified copy pages, these pages having links to modified copy pages, original pages, or other pages.

The group of modified copy pages along with any additional pages are hosted on a web server 9. They may be delivered in a static, or dynamic fashion, but must be accessible and crawl-able by the targeted search engine or engines. The hosting options are not limited to:
a. These pages may be hosted on the original web site and web server 9, perhaps in a separate sub-directory.
b. These pages may be hosted on a sub-domain of the original web site on a different web server 10.
c. These pages may be accessed by URLs leading to the original server 9, the original server 9 then obtaining the pages 11 from a second server 10 where the pages are stored or by which the pages are dynamically created.

Optionally, links may be added from one or more original pages to one or more modified copy pages or additional pages. These links may be invisible to web browser users, or may direct web browser users to original pages and targeted search engine crawlers to modified copy pages or additional pages.

Optionally, the crawling process may be repeated periodically, or after significant changes are made to the original pages. Means should be provided so that the modified copy pages of original web pages maintain their same URL from crawl to crawl.

Referring again to FIG. 2, Step 3 (27), the set of modified copy pages created above must be hosted on a web server so that search engine crawlers can crawl them, people will follow links from the search engines to them, and people will follow links on the pages to the original site.

Optionally add links from one or more prominent original pages to one or more prominent modified copy pages.

Referring again to FIG. 2, Step 4 (28), repeat Pass #2 (23) and Pass #3 (24) periodically.

### Pass 1 Algorithm and Functions

Pass #1: Crawl the Site, Downloading and Caching All Non-Skipped Local Pages.

### Algorithm

(0) Access the site settings and crawl progress data store (Table 2, The Crawl List) for this site. When opening a crawl list be sure to note the highest rowID, fetchID, and fOrder. Also note the highest sFile number in accordance with the current sFile prefix and sFile extension. (Don't assume all sFile values will be of this format.)

(1) Add any URL's in the starting URL list to the crawl list if they are not present. These URL's may have associated posted data, and may have associated forced modified copy file names and forced site map link text. Use the CheckOrgURL function to calculate the fURL and idURL for these pages.

Note that new records added to the crawl list may have these fields set initially: (Records are only added in pass #1)

| | |
|---|---|
| rowID = | unique integer for this record |
| State = | “Fetch”, “FetchNow”, “Skipped by URL”, |
| | “Skipped by Link”, or “Outbound” |
| idURL = | unique string for this record |
| | calculated from the original URL |
| fURL = | calculated from the original URL, |
| | preferred aliases are applied |
| fPost = | may be set if added from starting URL |
| | list |
| fOrder = | integer representing when this record |
| | was added relative to others, can be modified to delay |
| | fetching this page relative to others of the same state. |
| lnkFrm = | the rowID of the first URL, 0 if added |
| | from starting URL list |
| sFile = | may be set if added from the starting |
| | URL list, otherwise assigned programmatically. |
| lnkText = | may be set if added from the starting |
| | URL list, otherwise assigned programmatically. |
| hide = | calculated value, may be changed later |
| | with more information |

The starting URL list includes the fields (URL, optional posted data, optional sFile, and optional link text).
For each starting URL:
Apply the CheckOrgURL function to URL in order to calculate fURL, IsLocal, idURL, and Hide. Look up idURL in the crawl list.
If idURL is found and the state is not “Old” then do nothing.
if IsLocal then execute the SkipByURL function to determine whether or not this URL should be skipped due to its URL.
if idURL is found and the state is “Old” then update found record:

| | |
|---|---|
| rowID = | (no change) |
| State = | “Outbound” “Skipped by URL” or |
| | “Fetch” |
| idURL = | (no change) |
| fURL = | calculated value |
| fPost = | value from starting URL list |
| fOrder = | position in starting list |
| lnkFrm = | 0 (0 means from starting URL list) |
| sFile = | value from starting list (overriding |
| | “Old” value) |
| linkText = | value from starting list. |
| hide = | false (or calculated value, which ever) |

If idURL was not found then create a new record setting:

| | |
|---|---|
| rowID = | next value |
| State = | “Outbound”, “Skipped by URL” or |
| | “Fetch” |
| idURL = | calculated value |
| fURL = | calculated value |
| fPost = | value from starting URL list |
| fOrder = | position in starting list |
| lnkFrm = | 0 (0 means from starting URL list) |
| sFile = | value from starting list (overriding |
| | “Old” value) |
| linkText = | value from starting list. |
| hide = | false (or calculated value, which ever) |

Go on to the next starting URL.

(2) Find the next URL in the crawl list to fetch considering the State and fOrder fields. The next URL to crawl is the first record after sorting by State=“FetchNow”, “RetryNow”, “Fetch”, “FetchLater”, and “RetryLater”, and fOrder in ascending order. If there are no URL's left with their State set to any of these values then pass #1 is complete—go to pass #2.

(3) Fetch the page using fURL and fPost.

(4) If the fetch fails due to the mime type not being parse-able, then set the State to “Skipped by Type” and go to (2).

(5) If the fetch fails for some other reason then set the State like so and go to (2):

| “FetchNow” | => “RetryNow” |
|---|---|
| “RetryNow” | => “RetryLater” |
| “Fetch” => “RetryNow” | |
| “FetchLater” | => “RetryNow” |
| “RetryLater” | => “Failed” |

With this scheme, redirects are followed immediately and failed fetches are retried immediately and then once again at the end of the pass.

(6) If the fetch results in a 30X redirect or in a meta-refresh redirect then:
Set the State to “Redirect” and the redirectType to “30X” or “meta”
Use the CheckOrgURL function to calculate fURL, IsLocal, idURL, and Hide from the redirected-to URL. Look up idURL in the crawl list.
If idURL is found with a state not equal to “Old” then
set the redirectTo field of the current record to the rowID of the found record.
go to (2).
If IsLocal then execute the SkipByURL function to determine whether or not this URL should be skipped due to its URL.
If the idURL is found with the state equal to “Old” then
Set the redirectTo field of the current record to the rowID of the found record.
Update the “Old” record as follows:

| | |
|---|---|
| rowID = | (no change) |
| State = | “Outbound”, “Skipped by URL”, or |
| | “FetchNow” |
| idURL = | (no change) |
| fURL = | calculated value |
| fPost = | value from redirecting record |
| fOrder = | value from redirecting record |
| lnkFrm = | rowID of redirecting record |
| sFile = | If value from redirecting record |
| | is not blank then use it, otherwise (no change) => keep the |
| | value in the Old record. |
| linkText = | value from redirecting record |
| hide = | calculated value |

If the idURL is not found then
Set the RedirectTo field of the redirecting record to the rowID of the new record about to be created.
Create a new crawl list record setting:

| | |
|---|---|
| rowID = | next value |
| State = | “Outbound”, “Skipped by URL”, or |
| | “FetchNow” |
| idURL = | calculated value |
| fURL = | calculated value |
| fPost = | value from redirecting record |
| fOrder = | next value |
| lnkFrm = | rowID of redirecting record |
| sFile = | value from redirecting record |
| linkText = | value from redirecting record |
| hide = | calculated value |

(If this redirect is not “Outbound”, and is not “Skipped by URL”, then it will be followed next.)
go to (2)

(7) If there is a “location” header in the

HTTP response that is different than the fURL used to access the page, then treat this as a redirect, but continue processing the source code as if the redirect was followed. If the requested page is a domain or folder (no file name) with no query string, then create a new (or update an existing) record redirecting to this record. Otherwise make this record point to the new record.
Set the State to “Redirect” and the redirectType to “location”
Use the CheckOrgURL function to calculate fURL, IsLocal, idURL, and Hide from the location URL. Look up idURL in the crawl list.
If idURL is found with a state not equal to “Old” then
Set the requested record's RedirectTo field to the rowID of the found record, and go to (2).
If IsLocal then execute the SkipByURL function to determine whether or not this URL should be skipped due to its URL.
If the idURL is found with the state equal to “Old” then
Set the redirectTo field of the current record to the rowID of the found record.
Update the “Old” record as follows:

| | |
|---|---|
| rowID = | (no change) |
| State = | “Skipped by URL”, or “FetchNow” |
| idURL = | (no change) |
| fURL = | calculated value |
| fPost = | value from requested record |
| fOrder = | value from requested record |
| lnkFrm = | rowID of requested record |
| sFile = | If value from requested record is |
| | not blank then use it, otherwise (no change) => keep the value |
| | in the Old record. |
| linkText = | value from requested record |
| hide = | calculated value |

Else if the idURL is not found then
Set the RedirectTo field of the current record to the rowID of the new record about to be created.
Create a new crawl list record setting:

| | |
|---|---|
| rowID = | next value |
| State = | “Skipped by URL”, or “FetchNow” |
| idURL = | calculated value |
| fURL = | calculated value |
| fPost = | value from requested record |
| fOrder = | value from requested record |
| lnkFrm = | rowID of requested record |
| sFile = | value from requested record |
| linkText = | value from requested record |
| hide = | calculated value |

If state< >“FetchNow” then go to (2), otherwise proceed with this new record.

(8) Parse the page's source code and extract the title and meta tags. (This may be more conveniently done as a part of (6) while looking for meta-refresh redirects.)

(9) Use the SkipByContent function to test the fetched page's source code. If the page should he skipped then, set its State to “Skipped by Content”, set Hide=current value of Hide OR calculated value of Hide, and Go to (2).

(9.1) Use the SkipErrorPage function to test

the fetched page for being an error pages returned by the server as a regular page. If this is an error page then set its state=“Skipped Error Page” and go to (2). (Update Hide as above.)

(9.5) You may want to initialize a storage area for the rowID, TagType, Position, and Length of link URLs found in the source code below. This information would be placed in a comment at the top of the saved source code in step (16) and consequently save a little time when the files are parsed again in pass #4.

(10) Find the next URL link referenced in the source code. These should at least include HTML <a href> tags, <area href> tags, and perhaps <frame src> tags. Be sure to note any <base href> tags required to resolve relative URLs. For <a href> tags, also extract the <a href> tag and the source code between the <a href> tag and the </a> tag. If there are no more links to process, then go to (17)

(11) Apply the CheckOrgURL function to URL in order to calculate fURL, IsLocal, idURL, and Hide. Look up idURL in the crawl list.

12) If idURL is found AND the state is NOT “Old” then go to (10).

(13)If not Outbound then check SkipByURL, if not Skipped by URL then check SkipByLink.

(14) If idURL is found and the state is “Old” then update found record:

| | |
|---|---|
| rowID = | (no change) |
| State = | “Outbound”, “Skipped by URL”, |
| | “Skipped by Link”, or “Fetch” |
| idURL = | (no change) |
| fURL = | calculated value |
| fPost = | blank |
| fOrder = | next value |
| lnkFrm = | rowID of page being parsed |
| sFile = | (no change) keep value from Old |
| | record |
| linkText = | blank |
| hide = | calculated value |

(15) Else if idURL is not found then create a new record setting:

| | |
|---|---|
| rowID = | next value |
| State = | “Outbound”, “Skipped by URL”, |
| | “Skipped by Link”, or “Fetch” |
| idURL = | calculated value |
| fURL = | calculated value |
| fPost = | blank |
| fOrder = | next value |
| lnkFrm = | rowID of page being parsed |
| sFile = | blank |
| linkText = | blank |
| hide = | calculated value |

(16) go to (10)

(17) Save parsed source code for future reference as follows:
Set fetchID of parsed record to the next value.
Create a file header to save with the source code that includes:
a comment recording the URL fetched, date and time
a <base href> tag or equivalent so the file can be viewed with a browser
an optional comment as described in (9.5) containing the positions of ail the links found
Save source code to a file called “src##.htm” with the header at the top.

(18) Set the state of the parsed record to “Parsed” and Go to (2).

### Functions

### Function CheckOrgURL( )

input: orgURL=The original absolute URL being checked. Could be from the starting URL list, or be a redirect-to URL, or be a header location URL, or be a URL from a link found in a page's source code.

| | |
|---|---|
| output: | fURL = The URL used to access this page |
| | idURL = The string used to identify this URL |
| | IsLocal = True if orgURL passes the local |
| | test, otherwise URL is Outbound |
| | Hide = Goes to Hide field in crawl list |

Perform “is local” test on orgURL, which determines IsLocal and Hide. This test depends on the settings for this site and typically checks domain and host, but may check more.
If orgURL is Outbound then
set IsLocal=false
set Hide to calculated value
set fURL=orgURL
set idURL=orgURL
exit function
Calculate fURL from orgURL by performing URL aliasing and mandated optional manipulations:
Do any aliasing operations defined in the settings in which the URL is changed to a preferred URL that will access exactly the same page. For example “domain.com” may be changed to “www.domain.com”. Or “www.domain.com/homepage.cfm” may be changed to “www.domain.com”. (It is not necessary to perform aliasing from URL-A to URL-B if URL-A redirects to URL-B, because this is taken care of by the algorithm.)
Do any additional operation defined in the settings.
Calculate idURL from fURL, the goal being to map all variation of fURL that may be found in the site to a single idURL. For example if it is determined that the URL parameters are some times listed in different order (and this makes no difference), then the parameters should be sorted in the idURL. Session and tracking parameters would typically HOT be included in the idURL. If the case of specific parts of the URL don't matter and are used both ways, then these parts of the idURL should be one case or the other.

### Function SkipByURL( )

| | |
|---|---|
| input: | fURL = The fURL to be checked if it should be |
| | skipped |
| | idURL = The idURL to be checked if it should be |
| | skipped |
| output: | Hide = Goes to Hide field in crawl list. |
| return: | True if URL should be skipped, False otherwise |

Test the URL according to the settings for this site to determine if this URL should or should not be downloaded and examined to find more links. For example if the mime type of the URL is clearly not of the type that can be parsed, then the URL should be skipped. If this is the printable version of another page then this URL may be skipped. If this is “Buy” or “Add to cart” URL then it should probably be skipped. Also calculate and return Hide.

### Function SkipByContent( )

| | |
|---|---|
| input: | fURL = The fURL of the page to be tested |
| | idURL = The idURL of the page to be tested |
| | mTTL = The title of the page to be tested |
| | mDSC = The meta-description of the page to be |
| | tested |
| | mKW = The meta-keywords of the page to be |
| | tested |
| | page = The source code of the page to be |
| | tested |
| output: | Hide = Goes to Hide field in crawl list. |
| return: | True if page should be skipped, False otherwise |

Test if the page should not he parsed to find more links. Ideally this would be determined before fetching the page, but if that is not possible then you can test the content here in accordance with the settings for this site. Also calculate and return Hide.

### Function SkipErrorPage( )

| | |
|---|---|
| input: | fURL = The fURL of the page to be tested |
| | idURL = The idURL of the page to be tested |
| | mTTL = The title of the page to be tested |
| | mDSC = The meta-description of the page to be |
| | tested |
| | mKW = The meta-keywords of the page to be |
| | tested |
| | page = The source code of the page to be |
| | tested |
| output: | Hide = Goes to Hide field in crawl list. |
| return: | True if page is an error page, False otherwise |

Test if the page is a normally delivered error page. Also calculate and return Hide.

### Function SkipByLink( )

| | |
|---|---|
| input: | fURL = The fURL of the page to be tested |
| | idURL = The idURL of the page to be tested |
| | linkSrc = The source code in between the <a |
| | href> and the </a> |
| | aTag = The <a href> tag |
| output: | Hide = Goes to Hide field in crawl list. |
| return: | True if link should be skipped, False otherwise |

Test if the link should be skipped based on the <a href> tag or the source code between the <a href> tag the </a> tag. For example “buy” or “add to cart” links may be skipped by this test. Also calculate and return Hide.

### Pass 2 Algorithm

Pass #2: Optionally, Check Content of Fetched Pages Looking for Duplicates.

### Algorithm

(1) Calculate a hash (or some other source code identifying) value for each cashed source code file (ignoring the comments inserted at the top). Save this value temporarily in the htmURL field of the record. Note that this may be more conveniently done for each fetched page in Pass #1—step 17.

(2) Loop thru the “Fetched” records in the crawl list sorted by the hash in htmURL and then by fOrder—descending. Whenever the current record is found to have the same hash as the previous record then modify the current record as follows:

| | |
|---|---|
| state = | “Redirect” |
| redirectType = | “dupOf” |
| redirectTo = | rowID of previous record (or better, |
| | the first record with this hash) |

(3) (Now only unique fetched and parsed pages have their states set to “Parsed”.)

### Pass 3 Algorithm and Functions

Pass #3: Determine Which Parsed Pages Should Have Modified Copy Pages Created of Them and Calculate the Link URL's (htmURL's and jsURL's) That Will be Used in These Pages.

### Algorithm

(1) Get the next record from the crawl list with state not

equal “Old” and state not equal “Redirect”. If there are no more then go to (5).

(2) If state=“Fetched” then use the CopyOrNot function to determine whether or not to create a modified copy of this page. If so then set state=“Copy” and if sFile is blank, then assign a relative URL to the page and store it in sFile.

A simple way to assign URLs to the future modified copy pages is to simple define a file prefix like “p” and a file extension like “.htm” and then to number each page, p1.htm, p2.htm, p3.htm, etc.

The above example assumes all the modified copy pages will be served up from one folder on a web server—which doesn't have to be the case. The values of sFile could include one or more folders also like “product/p1.htm”. Various options are explained in the section “Host the modified copy pages on a web server.”

(3) Calculate htmURL and jsURL for the record, according to Table 1.

TABLE 1

| state | htmURL | jsURL |
|---|---|---|
| “Outbound” | fURL | blank |
| “Skipped by *”, | EntryURL( )^{a} | blank |
| “Error Page”, | | |
| “Failed”, and | | |
| “Parsed” | | |
| “Copy” | sFile made | EntryURL( )³ |
| | absolute^{b} | |

^{a}See the EntryURL function below.
^{b}Making the relative URL stored in sFile into an absolute URL depends on the location the modified copy pages will be hosted from. Other options are possible - see “Host the modified copy pages on a web server” below.

(4) Go to (1)

(5) Follow each “Redirect” record to its final destination record and copy the state, hide, htmURL, and jsURL fields back to the redirect record. (The redirectTo field marks a redirecting record even if the state is changed from “Redirect”.) If redirect loops are detected then set the state of the records in the loop, and leading to the loop, to “Redirect Loop”, and set the htmURL and jsURL fields to EntryURL and blank.

### Functions

### Function CopyOrNot( )

| | |
|---|---|
| input: | fURL = The fURL of the page to be tested |
| | idURL = The idURL of the page to be tested |
| | mTTL = The title of the page to be tested |
| | mDSC = The meta-description of the page to be |
| | tested |
| | mKW = The meta-keywords of the page to be |
| | tested |
| | page = The source code of the page to be |
| | tested |
| return: | True if page is an error page, False otherwise |

Test if the page should have a modified copy made of it our not. This test may depend on the likelihood of the original page being indexed in the targeted search engines.

### Function EntryURL( )

| | |
|---|---|
| input: | fURL = The fURL of the page to be tested |
| | idURL = The idURL of the page to be tested |
| return: | URL suitable for a browser to enter the site with |
| | and arrive at the corresponding page. |

Typically the result is fURL with any session parameters removed. In some cases the result could be a dynamic URL to a special script on the web server that initializes a session and then delivers or redirects to the desired page.

### Pass 4 Algorithm

Pass #4: Create the Modified Copy Pages Identified Above.

For each of the “Copy” records, do the following:
Start with the cashed source code page.
Read and remove the link position comment (created in pass#1—step 9.5) if it exists.
Replace link URLs with htmURLs from the crawl list. (Identify the destination crawl list record associated with any particular link URL by calculating the idURL from the link URL, or by using the link position data read above.)
Add JavaScript (or equivalent) to the page that loops thru all the links on the page looking for links with URLs recognized as htmURLs with associated jsURLs, and change the these link URLs to the jsURL. Ideally this script would run just after the page loads rather than when any particular link is clicked so that human viewers placing their cursor over a converted link will see the jsURL appear in the status bar of their browser.
Make sure all the other URLs referenced in the page (to images, form actions, etc.) resolve correctly depending on where the page will be hosted. The simplest way is to keep the <base href> tag inserted at the top of the page when it was cashed.
Optionally add a hit counter, or other tracking means, to the page.
Modify the title and met a tags of the page depending on site settings, which may involve extracting important text from the page. Save the new title and meta tags in the crawl list.
Do any other modifications to the page in order to enhance keyword relevancy, or to add specific links. For example a link may be added from the modified copy home page to a modified copy starting URL page that would not otherwise be linked to.
Save the resulting page in a folder according to it's sFile value.
Set the state of this record to “Copied”.

### Pass 5 Algorithm

Pass #5: Optionally Add Links onto Modified Copy Pages and/or Create Additional Pages to Help Them be Crawled by the Targeted Search Engines.

### Creating a Supplemental Site Map

Supplemental site map pages are created as follows, the goal being to create a link path to all the pages requiring the fewest number of hops and limiting the number of links per page to 50 or so.
Calculate the link text for each modified copy page according to settings for the site. Store this in the lnkText field. Note that some records may already have their link text defined.
Count the number of modified copy pages to determine how many levels of supplemental sitemap pages are required. Note that this scheme is based on 50 links per page, but could be adjusted to a different number. (Add the links to the sitemap page/s in order of fOrder.)

For 1 to 50 copied pages:
Create a single supplemental site map page with links to each modified copy page, using the lnkText field for the link text and the htmURL field for the destination URL. Add JavaScript to convert these links to jsURL.

For 51 to 2500 copied pages:
Create the first supplemental site map page (sitemap0.htm) with links to sitemap1.htm, sitemap2.htm, sitemap3.htm up to sitemap(n).htm where n=CEIL((number of pages−50)/49) These links have no corresponding jsURLs.
Add zero or more links onto sitemap0.htm leading to modified copy pages (as described above for 1 to 50 pages) for a total of 50 links on sitemap0.htm.
Create sitemap1,2,3,,,.htm referred to above with 50 links on each page, except for the last sitemap page that may have less links.

For 2501 to 125,000 copied pages:
In this case there will be three levels of supplemental site map pages. The first level contains only sitemap0.htm with 50 links to the second level. The second level contains sitemap1.htm up to a maximum of sitemap50.htm. These sitemap pages have 50 links on each but the last one to the third level sitemap pages. The third level contains sitemap1.html up to a maximum of sitemap2500.html, (notice the “1” in “html”) Only these third level sitemap pages have links to modified copy pages.
First create the third level sitemap pages, sitemap1.html to sitemap(m).html where m=CEIL(number of pages/50). The last one may not have 50 links, but all the others will. The links on each page are like described for 1 to 50 pages above.
Now create the first and second levels similar to how it is done for 51 to 2500 pages above, as follows:
Create the first supplemental site map page (sitemap0.htm) with links to sitemap1.htm, sitemap2.htm, sitemap3.htm up to sitemap(n).htm where n=CEIL((m−50)/49). These links have no corresponding jsURLs.
Add zero or more links to sitemap0.htm leading to the first of the third level sitemap pages for a total of 50 links on sitemap0.htm.
Create sitemap1,2,3,,,.htm referred to above with 50 links on each page, except for the last sitemap page that may have less links. These links point to the remainder of the third level sitemap pages not linked to from sitemap0.htm.
None of the links on levels one and two have jsURLs—they all lead to other sitemap pages.

You should add a link from one or more prominent modified copy pages to sitemap0.htm.

Note that an alternative to creating a sitemap to all the modified copy pages is to keep track of the link path from the modified copy home page to the other modified copy pages and then only include pages in the sitemap that are suspected not to get crawled by the targeted search engine.

### Systematically Add Links from Each Modified Copy Page to Other Modified Copy Pages

In this method, one or more links are added to each copied page leading to other copied pages. The simplest implementation is to loop thru the pages in fOrder and add a link from each page to the next page. Adding the link near the top is better than at the bottom because some search engine crawlers may not follow ail the links on each page.

Another option is to add a link to the next page and to the previous page. Another option is to link the most prominent copy page to the last copy page in fOrder and then link backwards back to the first page in fOrder.

These added links may or may not be visible to human visitors using web browsers. If they are visible then the link in the source code should go to the htmURL and JavaScript should be added to convert this link to jsURL. Visible or not, these links may links may or may not include link text calculated as described in (A). Invisible links use the htmURL and may or may not be converted by JavaScript to jsURL.

An alternative to inserting one or more new links near the top of the page is to modify one or more existing links near the top of the page. You could change the URL in the source code to point to the desired next copied page, but keep the jsURL the same. Another option is to put a link around an existing image in the header.

The best option may depend on the particular site being worked on.

Note that this operation may be more conveniently done in Pass #4.

### Insert Specific Links on Specific Pages as Defined by the Setting for the Site

If the copy pages are all linked to each other well, then no additional links may need to be added, or just a few in certain places need be added. This could be defined in the settings for the site, rendering (A) and (C) un-needed. This may be more conveniently done in Pass #4.

3. Host the Modified Copy Pages on a Web Server.

The set of modified copy pages created above must be hosted on a web server so that search engine crawlers can crawl them, and people will follow links from the search engines to them, and people will follow links on the pages to the original site.

The images, forms, JavaScript, etc on the modified copy pages should all work, and of course the htmURL links and the jsURL links should work.

There are many choices and options on how to host the copy pages:
All the pages may be hosted in one directory, or may be hosted in various directories. The directories would be calculated as a part of sFile and could match the directory of fURL if desired.
The pages may be hosted on the original domain, or on a separate domain or sub-domain. The original domain is best in order to take advantage of any link popularity the original site has.
The pages may be hosted on an original web site web server, or on an independent web server. Even if the pages are hosted on the original domain, they still could be served from an independent web server as follows: (This has the advantage of maintaining link popularity AMD not requiring access to the original web server.)
The modified copy page URLs are on the original domain, but the pages do not exist on the server.
When any of these pages are requested then the original web server fetches the page from the independent server and returns it to the requestor.
Note that these options are independent of each other. For example the pages could be hosted in directories exactly matching the original directories, could be hosted on the same domain, and could be served up from an independent web server. (In this case no <base href> tag would be required on the copy pages to make everything work, and links from copy page to copy page could be relative.)

4. Optionally Add Links from One or More Prominent Original Pages to One or More Prominent Modified Copy Pages.

The goal here is to allow search engine crawlers to follow links from the original site to the copied pages so that they will be indexed. However you don't want human visitors to follow these links. The links may be invisible, or may have JavaScript to cancel them or set their href to another original page. Whatever changes are made to original pages should be very simple because the operator of this system may not nave access to the original pages. Also remember that this system will crawl the original pages and see these links.

For example a link in the header of the original home page could be changed to point to the copied home page with an onClick event that changes the href back to the original value. Then the SkipByURL rules would be setup to skip this link.

Another example is to add a hidden link in the header of all the original pages to the copied home page, then make sure this link is skipped by the SkipByURL settings. Methods of hiding links are to use a hidden layer, surround the link with <no script> tags, create an un-referenced area map, create a link with nothing between the <a> and </a> tags, etc. You have to be sure that the targeted search engines will, follow these links and not penalize their use.

### 5. Repeat Steps (2) and (3) Periodically.

The original site should be re-crawled periodically as it's content is updated. In order not to confuse the search engines, modified copy page URLs should be maintained from crawl to crawl. This is done as follows:
Delete ail the records in the crawl list that do not have their state set to “Old” and that do not have their state set to “Copied” and their redirectTo field set to 0.
In the remaining records, update them like this:

| | |
|---|---|
| rowID = | (no change) |
| idURL = | (no change) <= this is an important one |
| State = | “Old” |
| hide = | true |
| lnkFrm = | blank or 0 |
| redirectTo = | 0 |
| redirectType = | blank |
| fURL = | (no change) |
| fPost = | (no change) |
| fOrder = | blank or 0 |
| sFile = | (no change) <= this is an important one |
| linkText = | blank |
| htmURL = | blank |
| jsURL = | blank |
| fetchID = | blank or 0 |
| mTTL = | blank |
| mDSC = | blank |
| mKW = | blank |

Start the process again, at step 2—Crawl site and create modified copy pages.

TABLE 2
CRAWL LIST TABLE

Crawl List Table:
The fields are: rowID, idURL,
state, hide, lnkFrm,
redirectTo, redirectType,
fURL, fPost, fOrder,
sFile, lnkText,
htmURL, jsURL,
fetchID, mTTL, mDSC, mKW
The states are: Old,
Fetch, FetchNow, FetchLater, RetryNow, RetryLater,
Redirect, Failed, Outbound,
Skipped by Link/URL/Type/Content, Error Page,
Parsed, Copy, Copied, Redirect Loop
The redirectTypes are: 30X, meta, location, dupOf

| | | |
|---|---|---|
| Field | Possible Values | Notes |

- state 0-5 “Old” 0, 1, 2, 3, 4, 5

“Fetch” 1-temp These URLs will be fetched in fOrder

“FetchNow” ^{1-temp} Used to follow redirects

immediately

“FetchLater” ^{1-temp} Used to delay the fetching of

certain pages. Can be set to this value manually.

“RetryNow” ^{1-temp} Set after fetch fails the

first time

“RetryLater” ^{1-temp} Set if fetch fails a second

time.

“Redirect” ^{1, 2} This URL leads to another URL, or

results in the same page as another URL. See redirectTo, and
redirect Type.

“Redirect Loop” ^{3, 4, 5} Indicates that a redirect

loop was discovered.

“Outbound” ^{1, 2, 3, 4, 5} If outbound then only (idURL,

State, and fOrder) are filled.

“Skipped by Link” ^{1, 2, 3, 4, 5} URL is skipped due to

the <a> tag or the source code between the <a> and </a> tags.

“Skipped by URL” ^{1, 2, 3, 4, 5} URL is skipped due to

it's fURL or idURL

“Skipped by Type” ^{1, 2, 3, 4, 5} URL is skipped because

it's mime type is un-parseable by this system.

“Skipped by Content” ^{1, 2, 3, 4, 5} URL is skipped due

to it's content.

“Error Page” ^{1, 2, 3, 4, 5} URL is skipped because it is

determined to be an error page.

“Failed” ^{1, 2, 3, 4, 5} This page did not download

successfully after three tries.

“Parsed” ^{1, 2, 3, 4, 5} This page was downloaded and

parsed to find links to other pages. Some of these will be
changed to “Copy” and then “Copied” in passes 3 and 4.

“Copy” ³ These pages will have modified copy

page created of them in pass #4, OR they are redirect pages
that lead to a page to be copied.

“Copied” ^{4, 5} These pages have had modified copy

pages created, OR they are redirect pages that lead to pages
with copies.

| | |
|---|---|
| - | rowID ⁰⁻⁵ unique integer Used as the primary key |

for Table 2.

| | |
|---|---|
| - | idURL ⁰⁻⁵ modified URL Unique string for this |

record calculated from the original URL in the CheckOrgURL
function.

| | |
|---|---|
| - | fURL ⁰⁻⁵ useable URL Used to fetch this page. |

Calculated in the CheckOrgURL function. Equals the original
URL after any preferred aliasing is done, and any ether
operations defined in the settings.

| | |
|---|---|
| - | fPost ⁰⁻⁵ data to post Used to fetch this page. |

Normally blank but may be filled for starting URL's. (Use a
“Memo” in MS Access field to take up less space.)

| | |
|---|---|
| - | RedirectTo ¹⁻⁵ (a rowID) The rowID of the |

page/URL this URL redirects to.

| | |
|---|---|
| - | RedirectType ¹⁻⁵ string Type of redirect = 30X, |

meta, location, or dupOf

| | |
|---|---|
| - | fOrder ¹⁻⁵ an integer The order links are |

found in. Pages are fetched in this order also. Can be
adjusted manually.

| | |
|---|---|
| - | lnkFrm ¹⁻⁵ (a rowID) The rowID of first page found |

linking to this one.

| | |
|---|---|
| - | Hide ⁰⁻⁵ True or False Used for creating proposal |

and manually examining crawl list. If true then this row is
hidden or sorted to the bottom.

| | |
|---|---|
| - | LnkText ⁵ string Link text used in optional |

supplemental site map pages. Usually assigned
programmatically, but may be set in the starting URL list. An
example would be “Home electronics - [XYZ model 200B digital
camera]” (The entire string is used and the part in the
square brackets is made into a link.)

| | |
|---|---|
| - | fetchID ¹⁻⁵ unique integer Identifies cashed source |

code file, file being saved as “src##.htm” After 1st pass the
only pages having these files will be when state = “Parsed”

| | |
|---|---|
| - | htmURL ²⁻⁵ useable URL (or temp. hash) |
| - | jsURL ⁵⁻⁵ useable URL |
| - | mTTL ¹⁻⁵ string Page title |
| - | mDSC ¹⁻⁵ string Page meta description |
| - | mKW ¹⁻⁵ string Page meta keywords |

Notes:
⁰ Exists before pass #1.
^{1-temp} Exists during pass #1, but not at the completion of pass #1.
¹ Exists after the completion of pass #1.
² Exists after the completion of pass #2.
³ Exists after the completion of pass #3.
⁴ Exists after the completion of pass #4.
⁵ Exists after the completion of pass #5.

1-20. (canceled)

21. A method for enabling content of a dynamic website to be crawled and indexed by a search engine,
the method comprising:
establishing crawling and conversion rules for the dynamic website;
crawling the dynamic website in accordance with said crawling and conversion rules and thereby downloading a first original web page;
creating a first new web page from said first original web page, the first new web page being assigned a URL compatible with said search engine; and
hosting first new web page being on a web server.

22. The method of claim 21 wherein the first new web page comprises:
a base tag; or
at least one modification, wherein the at least one modification is relative to the first original web page for enabling functions of the first original web page to work correctly on the first new web page.

23. The method of claim 21 wherein at least one link is added to the first new web page, wherein the at least one link leads to a second new web page.

24. The method of claim 21 wherein at least one second link in the first new web page leading to a second original web page is modified to lead to a corresponding second new web page.

25. The method of claim 24 wherein the at least one second link comprises at least one web browser link to the second original web page.

26. The method of claim 21 wherein web browsers are redirected from the first new web page to the first original web page.

27. The method of claim 21 wherein the first new web page comprises at least one second modification relative to the first original web page, wherein the at least one second modification comprises removing time sensitive features of the first new web page.

28. The method of claim 21 wherein the first new web page comprises at least one third modification relative to the first original web page, wherein the at least one third modification comprises adjusting a title of said first new web page.

29. A method for enabling a dynamic website to be indexed by a search engine, the method comprising:
storing information, regarding URL parameters used within the website; and
providing said information to a search engine.

30. The method of claim 29 further comprising:
storing said information regarding URL parameters used within the website in a first web page; and
downloading said first web page to the search engine.
